(19) United States
(12) Patent Application Publication
(10) Pub. No.: US 2024/0406307 A1
(43) Pub. Date: Dec. 5, 2024

(54) A WIRELESS DEVICE AND A METHOD FOR CHANGE A VOLUME OF THE WIRELESS DEVICE

(71) Applicant: ICOM INCORPORATED, Osaka (JP)

(72) Inventors: Kyouhei TAKASAGO, Osaka (JP); Shinsuke MURAKAMI, Osaka (JP)

(73) Assignee: ICOM INCORPORATED, Osaka (JP)

(21) Appl. No.: 18/621,341

(22) Filed: Mar. 29, 2024

(30) Foreign Application Priority Data
Jun. 5, 2023 (JP) 2023-092751

(51) Int. Cl. H04M 1/72466; H04M 1/60

(52) U.S. Cl. CPC H04M 1/72466; H04M 1/6041

(57) ABSTRACT

In a wireless device that can easily change a volume depending on whether a hands-free call function of the wireless device is on or off. The wireless device provided with a volume knob that changes the volume value according to the rotation angle of the knob, a volume change key that changes the volume value by pressing the key, and a hands-free call function on/off switching key that turns the hands-free call function on and off, and a controller for controlling the wireless device. The controller monitors whether the hands-free call function is on or off, and when the hands-free call function is on, the volume can be changed by operating the volume knob, and when the hands-free call function is off, the volume can be changed by operating the volume change key.

This application claims priority of Japanese Application No. 2023-092751, filed Jun. 5, 2023, the disclosure of which is hereby incorporated herein by reference in its entirety.

### FIELD OF THE INVENTION

The present invention relates to a technology for changing a volume value in a wireless device having a hands-free call function.

### DESCRIPTION OF THE RELATED ART

Regarding changing the volume value of wireless device such as a mobile phone, there is a known device that can reduce a reproduction volume of a content, etc., if a call is received while a user is viewing the video or audio of the content, etc. And, in wireless device that has multiple audio output destinations, it is known that a volume of a content etc. can be set to the user's preference, if the user wants to output both voice of a call and voice of the content etc. to the respective audio output destinations during the call (for example, see Japanese Patent No. 4369400).

### RELATED ART DOCUMENTS

### Patent Documents

Japanese Patent No.4369400.

### SUMMARY OF THE INVENTION

### Problems to be Solved by the Invention

The wireless device shown in Japanese Patent No. 4369400 changes the audio output of a plurality of audio output destinations according to a volume setting value that is associated with each audio output destination in advance. But this does not make it easy to set the volume setting value.

In conventional handheld wireless devices, a volume knob on the top of the device is rotated to change the volume value according to the rotational position, or a pressable key on the side of the device is set as a volume change key. It only has one way to change the volume, either changing the volume value.

The volume change means using the volume knob changes the volume value according to the rotational position of the volume knob, so that it is suitable for understanding the volume value and changing the volume value, while the wireless device is fixed to the chest or waist. On the other hand, a configuration in which keys on the side surface of the wireless device are used as the volume changing means is suitable for changing the volume value by pressing the keys on the side surface of the wireless device while holding the wireless device to the ear like a telephone receiver.

However, in a wireless device that has both a transceiver function and a telephone function (particularly an IP phone function), in case that the volume change means is the volume knob, when changing the volume value while holding the wireless device to user's ear like a telephone receiver, the volume knob is difficult to see. Furthermore, it is necessary to move user's hand that is not holding the wireless device to the volume knob, making it difficult to change the volume value. On the other hand, if the keys on the side of the main unit are used as volume change keys, if user changes the volume value while the wireless device is fixed to user's chest or waist, it will be difficult to see a screen display indicating the volume value, making it difficult to understand the volume value.

The present invention solves the above-mentioned problems, and aims to provide a wireless device and a method for changing the volume thereof, in which the volume value can be easily changed depending on whether the hands-free call function is on or off.

### Means of Solving the Problems

The present invention is a wireless device provided with a controller, a volume knob that changes a first volume value according to a rotation angle of the volume knob, and a volume change key that changes a second volume value by pressing the volume change key; wherein,
the controller controls on/off of a hands-free call function provided with the wireless device,
the first volume value can be changed by operating the volume knob, when the hands-free call function is on, and
the second volume value can be changed using the volume change key, when the hands-free call function is off.

It is desirable that the wireless device has a transceiver function and a telephone function, and
the controller turns on the hands-free call function when starting a call using the transceiver function, and turns off the hands-free call function when starting a call using the telephone function.

It is desirable that the wireless device further provided with an on/off switch key of the hands-free call function that can be operated by a user, and
the controller switches the hands-free call function on/off when the on/off switch key is operated during a call.

It is desirable that in the wireless device, the controller turns on the hands-free call function when the call ends.

It is desirable that in the wireless device, the volume knob is provided on the top surface of a main body of the wireless device, and the volume change key is provided on the side of the main body of the wireless device.

It is desirable that in a method for change a volume of the wireless device with a hands-free calling function that can be turned on/off; wherein,
when the hands-free call function is on, change the volume by adjusting the rotation angle of the volume knob, and
when the hands-free call function is off, change the volume by pressing the volume change key.

### Effects of the Invention

With the wireless device or the method for changing the volume according to the embodiment of the present invention, when the hands-free call function is on, the wireless device can be used as a transceiver to talk while being away from the face, and the first volume value can be easily changed by operating the volume knob. On the other hand, when the hands-free calling function is off, user can talk by holding the wireless device to user's ear as a telephone and easily change the second volume value by operating the volume change key with user's hand that is holding the wireless device. Therefore, compared to conventional wireless devices that only have a volume knob to change the volume, when using the device as a telephone held up to user's ear, there is no need to reach user's hand that is not holding the wireless device to reach the volume knob, and the volume can be easily changed and adjusted.

### BRIEF DESCRIPTION OF THE DRAWINGS

FIG. 1A is a side view of a wireless device having a transceiver function and a telephone function according to an embodiment of the present invention;

FIG. 1B is a front view of the wireless device;

FIG. 2 is a diagram showing a schematic configuration related to changing the volume of a controller of the wireless device;

FIG. 3 is a flowchart of the volume change operation by operating the volume knob of the wireless device;

FIG. 4 is a flowchart of the volume change operation by operating the volume change key of the wireless device; and

FIG. 5 is a diagram showing an example of state transition of a hands-free call function by a controller of the wireless device.

### DESCRIPTION OF THE EMBODIMENTS

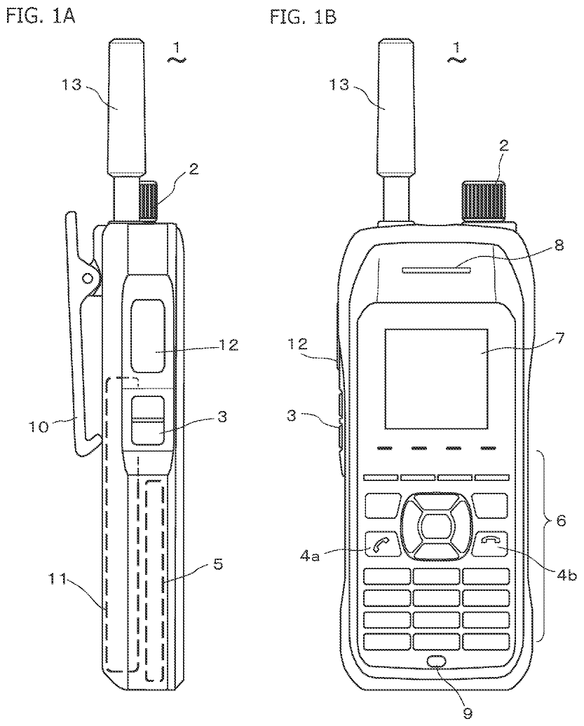

Hereinafter, a wireless device having a transceiver function and a telephone function (particularly an IP telephone function) and a method for changing the volume thereof according to an embodiment of the present invention will be described with reference to the drawings. FIGS. 1A and 1B show a side view and a front view of a wireless device 1 according to an embodiment. In these figures, the wireless device 1 includes a volume knob 2 that changes a first volume value according to the rotation angle, and a volume change key 3 that changes a second volume value when pressed. The wireless device 1 includes a call key 4a set as an on/off switch key 4 for switching an on/off of a hands-free call function, and a controller 5 for controlling the wireless device 1. Here, the hands-free call function is a function that, when turned on, allows the user to talk while keeping the wireless device 1 away from his or her face. On the other hand, when the hands-free call function is off, it is suitable for the user to talk while holding the wireless device 1 to his ear. For example, the wireless device 1 is configured to have different volume values when the hands-free call function is on and when it is off. Thereby, when the hands-free call function is on, the volume value can be set to a value suitable for the user to hold the wireless device 1 away from his face while talking. Further, when the hands-free call function is turned off, the volume value can be set to a value suitable for a user to talk while holding the wireless device 1 to his ear.

The volume knob 2 is provided protruding from the top surface of an exterior case (hereinafter referred to as wireless device body) of the wireless device 1, and has a shape that is easy to grip and turn with fingers. A volume scale may be displayed on the top surface of the wireless device body along the rotation direction of the knob. The volume change key 3 is provided on the side of the wireless device body (left side when looking at the wireless device body from the front), when the upper part of the key is pressed, the volume value increases by one level, and when the lower part of the key is pressed, the volume value decreases by one level. The volume change key 3 may have a tumbler shape, or may be a button divided into two parts, upper and lower. It is desirable that the key 3 is located at a position where it can be easily operated with a free finger when the left and right sides surface of the wireless device body is held from the back side with the fingers.

In this embodiment, the hands-free call function on/off switching key 4 is set to the call key 4a among the various operation buttons 6. The call key 4a is a key that is pressed when receiving or making a call to use the wireless device 1 as a telephone. The hands-free call function is set to be turned on/off by pressing and holding the call key 4a.

The wireless device 1 is provided with various operation buttons 6 and an LCD display 7 on the front of its body. The wireless device 1 includes a controller 5, a speaker 8, and a microphone 9 in the body. A belt clip 10 and a battery 11 are attached to the back of the body. The various operation buttons 6 include an on-hook key 4b for ending a telephone call, numeric keys, menu selection buttons, and the like. A PTT (Push to Talk) key 12 is provided adjacent to the volume change key 3 on the side surface of the body of the wireless device, and is pressed during a call using the transceiver function. An antenna 13 is provided adjacent to the volume knob 2 on the top surface of the wireless device body. The LCD display 7 displays the volume value by operating either the volume knob 2 or the volume change key 3, and also displays whether the hands-free call function is on or off.

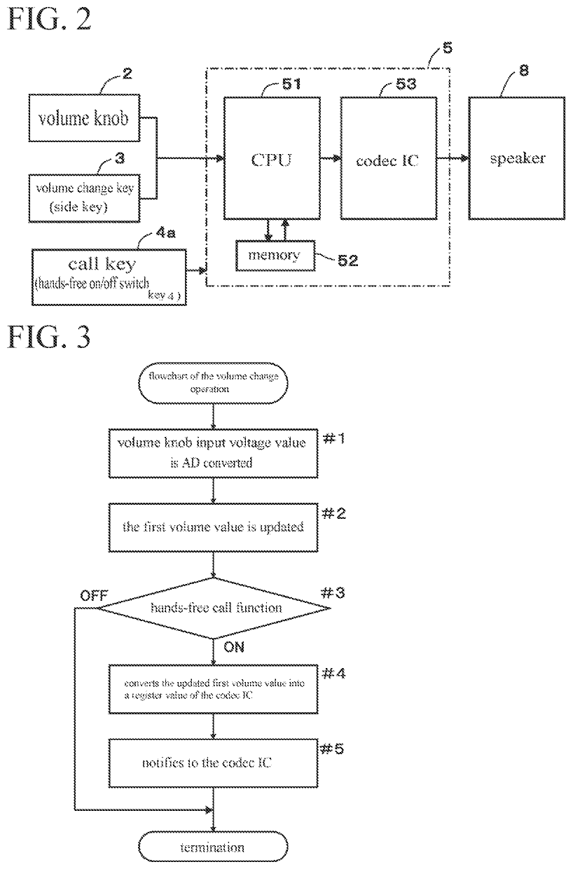

FIG. 2 shows a schematic configuration of the controller 5 of the wireless device 1 related to changing the volume. In FIG. 2, the controller 5 includes a CPU 51, memory 52 consists of a ROM (read only memory) and a RAM (random access memory) that stores programs for wireless device operation and volume change processing, and user settings including volume values. The controller 5 also includes a codec IC 53 for changing the volume. As a volume change process, the CPU 51 monitors the states of the volume knob 2, volume change key 3, and call key 4a (hands-free call function on/off switching key 4) at a predetermined cycle. Then, the CPU 51 increases or decreases the volume value based on the operation amount of the volume knob 2 or the volume change key 3 according to whether the hands-free call function of the wireless device 1 is turned on or off. Then, the CPU 51 notifies the codec IC 53 of the increased or decreased volume value, and the codec IC 53 outputs it to the speaker 8.

Specifically, the CPU 51 has the first volume value that is changed by the volume knob 2 when the hands-free call function is on, and the second volume value that is changed by the volume change key 3 when the hands-free call function is off. The CPU 51 converts the volume value into a register value of the codec IC 53 corresponding to the volume value, and notifies the codec IC 53 of the value, thereby the volume of the sound output from the speaker 8 is changed.

The first volume value is a volume value corresponding to the rotation angle of the knob 2, and is directly watched by the CPU 51 sequentially. Further, the second volume value is a volume value corresponding to the amount of operation of the volume change key 3, and is stored in the memory 52.

Here, the basic operation of the wireless device 1 is set so that the hands-free call function is turned on when the transceiver function is used, and the hands-free call function is turned off when the telephone function is used. When the hands-free call function is on, the first volume value can be changed by operating the volume knob 2 on the top surface of the wireless device. When the hands-free call function is off, the switching means is automatically switched to the volume change key 3 on the side of the wireless device, and the second volume value can be changed by operating the volume change key 3.

In addition, as an operation different from the above basic operation, the hands-free call function can be turned on/off by pressing and holding the call key 4a during a call, and when the call ends, the function shifts to standby mode. When a call using the transceiver function or the telephone call function is started again, the basic operation can be automatically returned. Note that the termination of a call here means, for example, when a predetermined period of time has elapsed without any transmission/reception when using the transceiver function, when the power (on-hook) key 4b is pressed when using the telephone function, or when a call may be disconnected. For example, if the basic operation when using the transceiver function is to turn on the hands-free call function, press and hold the call key 4a to turn off the hands-free call function, and when the call ends with the hands-free call function off, by being set to return to the basic operation automatically, the hands-free call function can be turned on when a call using the transceiver function is started again.

Furthermore, while the user is pressing the PTT (Push to Talk) key 12 in order to use the transceiver function, the CPU 51 determines that the hands-free call function is on. Further, the hands-free calling function can be set to be turned off when the user operates the numeric keypad to use the telephone function.

FIG. 3 shows the operation of changing the first volume value by operating the volume knob 2. In FIG. 3, the CPU 51 periodically AD converts the input voltage from the volume knob 2, and when the volume knob 2 is rotated, the input voltage value is AD converted (#1), and the first volume value is updated according to the converted value (#2). When the hands-free call function is on (ON in #3), the CPU 51 converts the updated first volume value into a register value of the codec IC 53 (#4), notifies this to the codec IC 53 (#5), and changes the first volume value. When the hands-free call function is off (OFF in #3), the CPU 51 does not notify the codec IC 53 of the updated first volume value and does not change the volume.

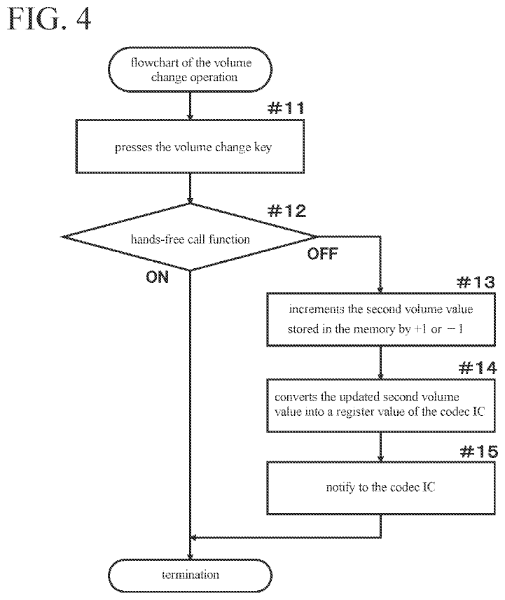

FIG. 4 shows the operation of changing the second volume value by operating the volume change key 3. In FIG. 4, the CPU 51 monitors the on/off state of the hands-free call function, and even if the user presses the volume change key 3 (#11), when the hands-free call function is on (ON in #12), the process of changing the second volume value by pressing the volume change key 3 is not performed. When the hands-free call function is off (OFF in #12), the CPU 51 performs volume change processing by pressing the volume change key 3. In the volume change process, the CPU 51 increments the second volume value stored in the memory 52 by +1 or −1 (#13), converts the updated second volume value into a register value of the codec IC 53 (#14). This is notified to the codec IC 53 (#15), and the volume is changed.

As described above, the basic operation of the wireless device 1 is to turn on the hands-free calling function when using the transceiver function, and turn off the hands-free calling function when using the telephone function. Therefore, when the hands-free call function is on (when the transceiver function is used), the first volume value is changed according to the rotation angle of the volume knob 2, but the operation using the volume change key 3 is not accepted. In addition, when the hands-free call function is off (when the telephone function is used), the operation of the volume change key 3 is automatically enabled when a telephone call starts, and the second volume value is changed by accepting the pressing operation. At this time, when the volume knob 2 is rotated, the volume is updated to the first volume value corresponding to the rotation angle, but the volume is not changed.

With conventional wireless devices that only have a volume knob as a means of changing the volume, in order to change the volume when talking while holding the wireless device to user's ear, the user have to reach out to the volume knob with the hand that is not holding the wireless device and turn the knob, then its operation is not easy. On the other hand, according to the wireless device 1 of the present embodiment, when making a call by holding the wireless device 1 to user's ear as a telephone, the volume change means automatically switches to the volume change key 3, so that user have to do is press down on the key 3 with the finger of the hand holding wireless device 1, and the operation is simple. Furthermore, when making a call with the wireless device 1 as a transceiver away from the user's face, the volume value can be changed by rotating the volume knob 2. In this way, the volume value can be easily changed when talking with the wireless device 1 held to the ear or when talking with the wireless device 1 away from the face.

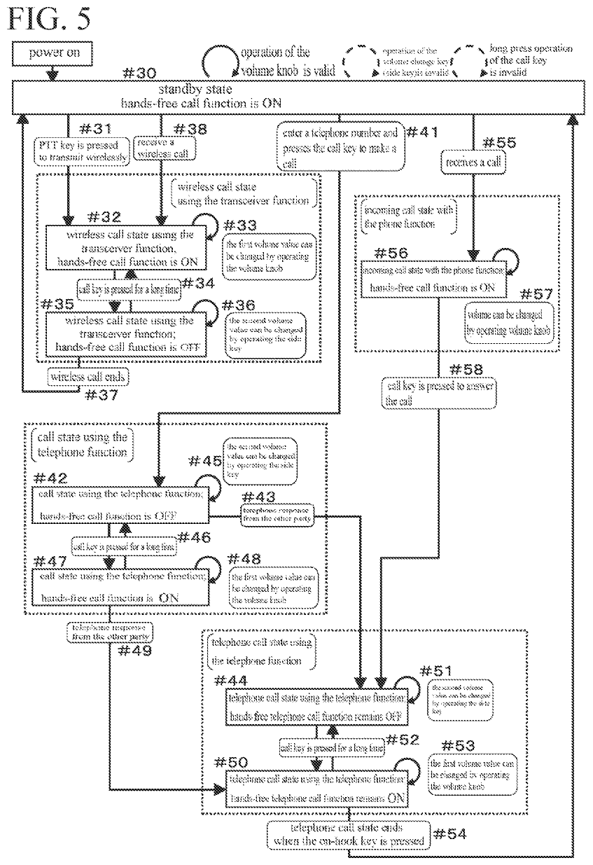

An example of transition of the hands-free state by the controller of the wireless device 1 will be described below with reference to FIG. 5. In FIG. 5, when the wireless device 1 is powered on, it enters a standby state, and the hands-free call function is turned on (hereinafter referred to as ON) (#30). In this standby state, the operation of the volume knob 2 is valid, but the operation of the volume change key 3 (denoted as the side key in FIG. 5) and the long press operation of the call key 4a (on/off switch key 4) are invalid. When the PTT key 12 is pressed to transmit wirelessly from the standby state (#31), a wireless call state is entered using the transceiver function with the hands-free call function ON (#32).

In this wireless communication state using the transceiver function, the first volume value can be changed by operating the volume knob 2 (#33). When the call key 4a is pressed for a long time in this state (#34), the hands-free call function is switched off (hereinafter referred to as OFF) (#35) while maintaining the wireless call state using the transceiver function. In this state, the second volume value can be changed by operating the side key (#36). When the user stops pressing the PTT key 12 during a wireless call using the transceiver function, the wireless call ends (#37) and the wireless device 1 returns to the standby state. Even when the wireless device 1 receives a wireless call while in the standby state (#38), the wireless device 1 enters a wireless call state using the transceiver function with the hands-free call function ON (#32).

While the wireless device 1 is in the standby state (#30), the user enters a telephone number and presses the call key 4a to make a call (#41) so that the wireless device 1 enters in call state using the telephone function with the hands-free call function OFF (#42). When there is a telephone response from the other party's device (#43), the hands-free telephone call function remains OFF and a telephone call state is entered using the telephone function (#44). In the telephone call originating state (#42) using the telephone function described above, the second volume value can be changed by operating the side keys (#45). When the call key 4a is pressed for a long time while the telephone function is making a call (#46), the hands-free call function is turned ON (#47) while the telephone function is making a call. In this state, the first volume value can be changed by operating the volume knob 2 (#48).

In a state of a telephone call using the telephone function with the hands-free call function ON (#47), if the user receives a call response from the other party's phone (#49), the telephone call will continue using the telephone function with the hands-free call function ON (#50). In the telephone call state (#44) using the telephone function with the hands-free call function OFF, the second volume value can be changed by operating the side keys (#51). Further, in the telephone call state (#50) with the hands-free telephone function ON, the first volume value can be changed by operating the volume knob 2 (#53). The telephone call state (#44) using the telephone function with the hands-free call function OFF and the telephone call state (#50) using the telephone function with the hands-free call function ON can be switched by long press of the call key 4a (#52). The telephone call state (#50) using the telephone function ends when the on-hook key 4b is pressed (#54), and the wireless device 1 enters the standby state (#30).

When wireless device 1 in standby mode (#30) receives a call from the other party's device (#55), the wireless device 1 enters the incoming call state (#56) with the phone function with the hands-free call function ON, and the volume can be changed by operating volume knob 2 (#57). When the call key 4a is pressed to answer the call (#58) in the incoming call state (#56) using the telephone function, the hands-free call function is automatically turned OFF and the telephone call state using the telephone function is entered (#44). Note that if the other party's device is also an equivalent wireless device, the call is not made directly between the wireless devices, but via a wireless controller (server) or SIP server. Further, the above is an example of the transition of the hands-free state, and it can be changed as appropriate.

The present invention is not limited to the configuration of the above embodiment, and various modifications are possible. In the above description, the volume knob 2 is provided on the top surface of the wireless device body, and the volume change key 3 is provided on the side surface of the wireless device body. Means for changing the volume value can be arbitrarily arranged and configured as long as it is suitable for changing the volume value when using each of the transceiver function and the telephone function. In addition, although the on/off switching key 4 for the hands-free call function is performed by pressing and holding the call key 4a among the various operation buttons 6 in the above example, it is not limited to this, and may be configured as desired.

Further, the wireless device 1 may have only a transceiver function or only a telephone function by changing the settings from the basic operation. In addition, it has a configuration in which audio output is output from the earphone jack instead of the speaker, and when audio is output from the earphone jack, the volume change means is not switched, but only the first volume value can be changed using the volume knob 2.

### DESCRIPTION OF THE REFERENCE NUMERAL

1 wireless device
2 volume knob
3 volume change key (side key)
4 hands-free call function on/off switching key
4a call key (hands-free on/off switch key)
4b on-hook key
5 controller
51 CPU
52 memory
53 codec IC
6 various operation buttons
7 LCD display
8 speaker
9 microphone
10 belt clip
11 battery
12 PTT key
13 antenna

What is claimed is:

1. A wireless device provided with a controller, a volume knob that changes a first volume value according to a rotation angle of the volume knob, and a volume change key that changes a second volume value by pressing the volume change key; wherein,
the controller controls on/off of a hands-free call function provided with the wireless device,
the first volume value can be changed by operating the volume knob, when the hands-free call function is on, and
the second volume value can be changed using the volume change key, when the hands-free call function is off.

2. The wireless device in accordance with claim 1, wherein the wireless device has a transceiver function and a telephone function, and
the controller turns on the hands-free call function when starting a call using the transceiver function, and turns off the hands-free call function when starting a call using the telephone function.

3. The wireless device in accordance with claim 2, wherein the wireless device further provided with an on/off switch key of the hands-free call function that can be operated by a user, and
the controller switches the hands-free call function on/off when the on/off switch key is operated during a call.

4. The wireless device in accordance with claim 3, wherein
the controller turns on the hands-free call function when the call ends.

5. The wireless device in accordance with claim 1, wherein the volume knob is provided on the top surface of a main body of the wireless device, and the volume change key is provided on the side of the main body of the wireless device.

6. A method for change a volume of the wireless device with a hands-free calling function that can be turned on/off; wherein,
when the hands-free call function is on, change the volume by adjusting the rotation angle of the volume knob, and
when the hands-free call function is off, change the volume by pressing the volume change key.

7. The wireless device in accordance with claim 2, wherein the volume knob is provided on the top surface of a main body of the wireless device, and the volume change key is provided on the side of the main body of the wireless device.

8. The wireless device in accordance with claim 3, wherein the volume knob is provided on the top surface of a main body of the wireless device, and the volume change key is provided on the side of the main body of the wireless device.

9. The wireless device in accordance with claim 4, wherein the volume knob is provided on the top surface of a main body of the wireless device, and the volume change key is provided on the side of the main body of the wireless device.
